(19) United States
(12) Patent Application Publication
(10) Pub. No.: US 2009/0150829 A1
(43) Pub. Date: Jun. 11, 2009

(54) METHOD FOR DISPLAYING ON-SCREEN DISPLAY

(75) Inventor: SHIAO-WEI LEE, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/189,099

(22) Filed: Aug. 8, 2008

(30) Foreign Application Priority Data
Dec. 6, 2007 (CN) 200710202873.0

(51) Int. Cl. G06F 3/048

(52) U.S. Cl. 715/837

(57) ABSTRACT

A method for displaying an on-screen display (OSD) is disclosed. An OSD with a first and second icons superimposed thereon is firstly rendered with a first color palette. The first and second icons are overlapped. The first icon is rendered with a second color palette and superposed over the originally displayed first icon. The second color palette is substantially similar to the first color palette but replaces an indexed color of the first color palette corresponding to the background color of the originally displayed first icon with a transparent color and another indexed color of the first color palette corresponding to the foreground color of the originally displayed first icon with a non-color color. The second icon is rendered with the first color palette and superposed over the originally displayed second icon.

### BACKGROUND

1. Technical Field

The invention relates to methods for displaying on-screen displays and, particularly, to a method for displaying an on-screen display, which in a previous view thereof has a number of overlapped icons but in a subsequent view one or more of the overlapped icons is removed.

2. Description of the Related Art

An on-screen display (OSD), generally used by display devices, is an image superimposed on a screen picture to display information and/or settings menus of the display devices. The OSD may include a number of icons indicative of a variety of statuses and/or functionalities of the display devices respectively. It is common that in one view of the OSD two or more icons are overlapped to indicate a status of the display devices, but in another view one or more of the overlapped icons are removed, or erased, from the OSD to indicate another status of the display devices. This erasing sometimes destroys the icon(s) which is desired to remain but overlapped with the erased one(s). A great portion of the OSD, even the entire OSD, therefore may be required to be re-rendered, introducing flicker and increasing the burden of the display device.

Therefore, it is desirable to provide a method for displaying an OSD, which can overcome the above-mentioned problem.

### SUMMARY

In an exemplary embodiment, a method for displaying an on-screen display (OSD) is disclosed. An OSD with a first and second icons superimposed thereon is firstly rendered with a first color palette. The first and second icons are overlapped. The first icon is rendered with a second color palette and superposed over the originally displayed first icon. The second color palette is substantially similar to the first color palette but replaces an indexed color of the first palette corresponding to the background color of the originally displayed first icon with a transparent color and another indexed color of the first palette corresponding to the foreground color of the originally displayed first icon with a non-color color. The second icon is rendered with the first palette and superposed over the originally displayed second icon.

### BRIEF DESCRIPTION OF THE DRAWINGS

FIG. 1 is a schematic view of a digital still camera to which a method for displaying an on-screen display (OSD) in accordance with an exemplary embodiment is applied.

FIG. 2 is a schematic view showing a display principle of the digital still camera of FIG. 1.

FIG. 3 is a flowchart of the method, according to another exemplary embodiment.

FIG. 4 is a schematic view showing a working example of the method of FIG. 3.

### DETAILED DESCRIPTION OF THE EMBODIMENTS

Embodiments of the present method for displaying on-screen display (OSD) will now be described in detail with reference to the accompanying drawings. The method can be applied to a variety of electronic devices, such as desktop or laptop computers, cameras, gaming devices, or mobile phones. In the following described embodiments, the method is applied to a digital still camera (DSC).

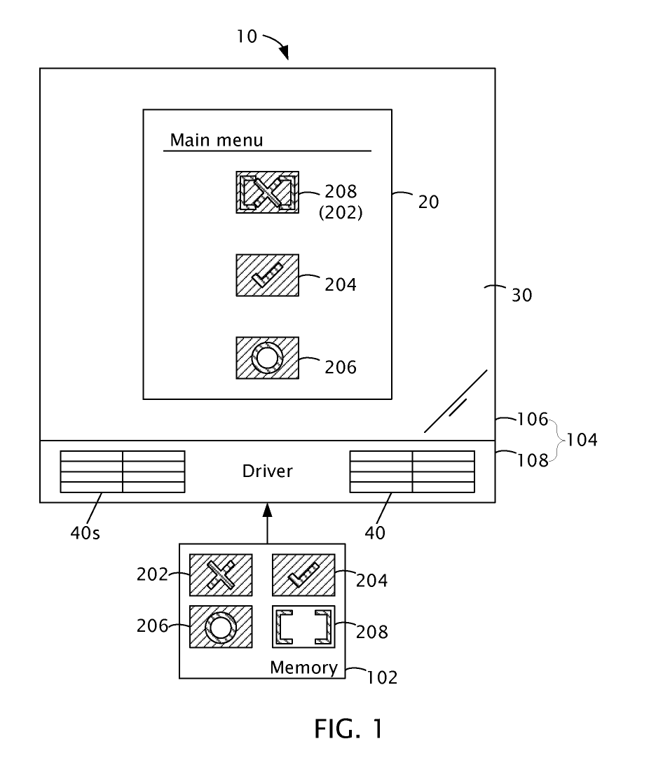

Referring to FIG. 1, a DSC 10, to which a method for displaying a OSD 20 in accordance with an exemplary embodiment is applied, includes a memory 102 and a display device 104. The memory 102 stores a library of images and icons therein in a form of data file. The display device 104 includes a display panel 106 and a driver 108. The display panel 106 is configured for displaying a screen picture 30 with the OSD 20 superimposed thereon. The driver 108 is configured for receiving images and icons from the memory 102 and rendering them on the display panel 106.

Before discussing details of the embodiment of the method, it is beneficial to explain the display principle of the DSC 10.

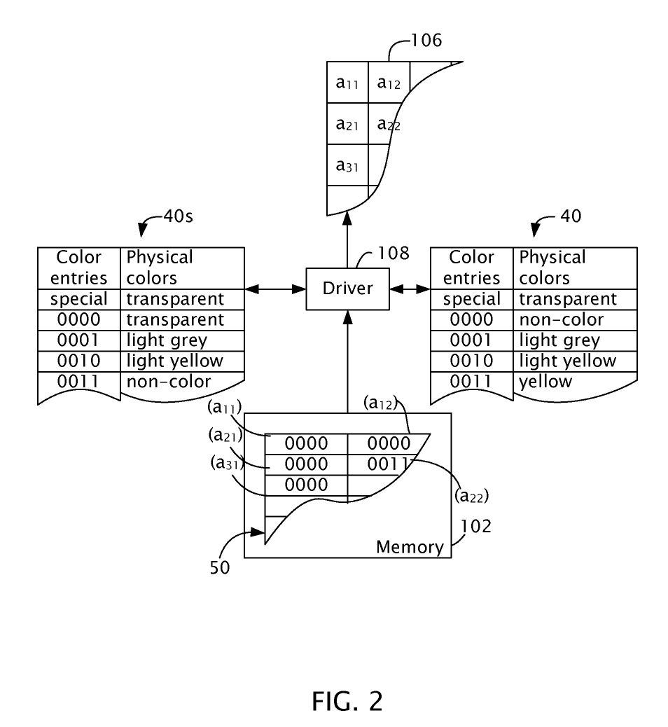

Referring to FIG. 2, the display panel 106 includes an array of display pixels, e.g., a₁₁, a₁₂, a₂₁, a₂₂ and a₃₁, each of which is of a predetermined color depth, i.e., the total number of colors can be physically displayed by the pixels. The driver 108 commonly renders the images or icons on the display panel 106, i.e., colors the corresponding pixels of the display panel 106, with, e.g., a color palette 40. The color palette 40 is typically a color look-up table and includes a collection of color entries (logical colors), e.g., 4-bit binary integers, and a collection of physical colors, e.g., 16 colors, where each color entry is associated with a physical color, for example, color entry ‘0010’ is associated with physical color ‘light yellow’.

When rendering an image, the driver 108 firstly reads a corresponding image file 50 which includes a section of image pixel data, i.e. color entries, such as (a₁₁), (a₁₂), (a₂₁), (a₂₂) and (a₁₃) from the memory 102, where (a₁₁), (a₁₂), (a₂₁), (a₂₂) and (a₁₃) will be displayed by the corresponding display pixels a₁₁, a₁₂, a₂₁, a₂₂ and a₃₁ respectively, secondly looks up the corresponding physical colors in the color palette 40 based on the color entries, and colors the corresponding display pixels with corresponding indexed physical colors.

The physical colors include a non-color physical color, which is associated with the color entry ‘0000’.

A transparent color is employed in image overlaying. When superimposing an image over a background, some display pixels of the background may be required to remain. These remaining display pixels are regarded as being recolored with the transparent color during the image overlaying.

Returning back to FIG. 1, in order to give a better understanding of the present embodiment, an example of the OSD 20 is given. The OSD 20 of this exemplary embodiment is a settings menu and includes a first icon 202, a second icon 204, a third icon 206, and a fourth icon 208. Where the icons 202, 204, 206 are designated to three options of the settings menu respectively. Each of the option is associated with a corresponding functionality of the DSC 10. The fourth icon 208 is designated to a focus point, e.g., a highlighted bracket, of the setting menu. In operation, if the fourth icon 208 is superposed over the icon 202, 204, or 206, the corresponding option is focused, i.e., bracketed, to indicate a selected status of the option, and a corresponding functionality of the DSC 10 is triggered.

All the icons 202, 204, 206 and 208 typically have a uniform overall shape and size, and consist of a characterized foreground, e.g., symbols ‘×’, ‘✓’, ‘∘’, or ‘[]’, colored with foreground colors respectively, and a background colored with a background color, shown in the FIG. 1 by different textures. In this embodiment, since the icons 202, 204, 206, 208 are similar in shape and size and the fourth icon 208 is configured for superposing the icon 202, 204, or 206, the background of the fourth icon 208 is colored with the transparent color. Therefore, the display pixels of the display 106 corresponding to the original background are remained when superposing the fourth icon 208 over the icon 202, 204, or 206. Otherwise, the icon 202, 204, or 206 which is superposed by the fourth icon 208 will be entirely obscured. However, in other alternative embodiments, if two or more icons are only partially overlapped, the backgrounds of the icons can be colored with any physical color.

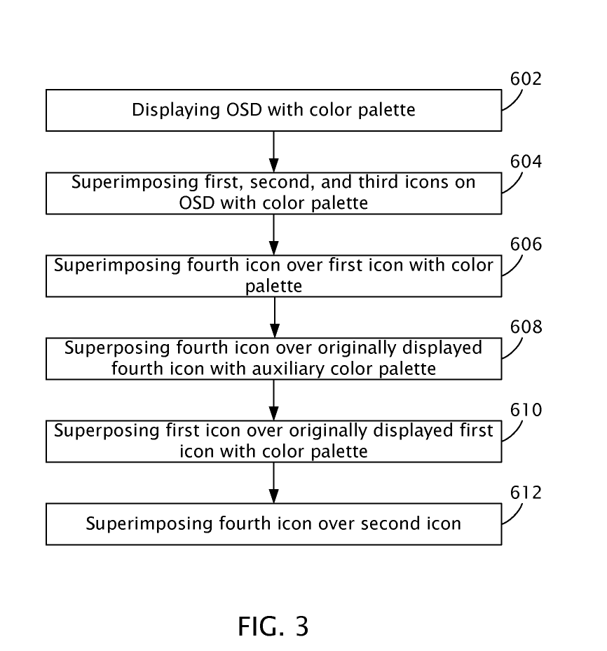

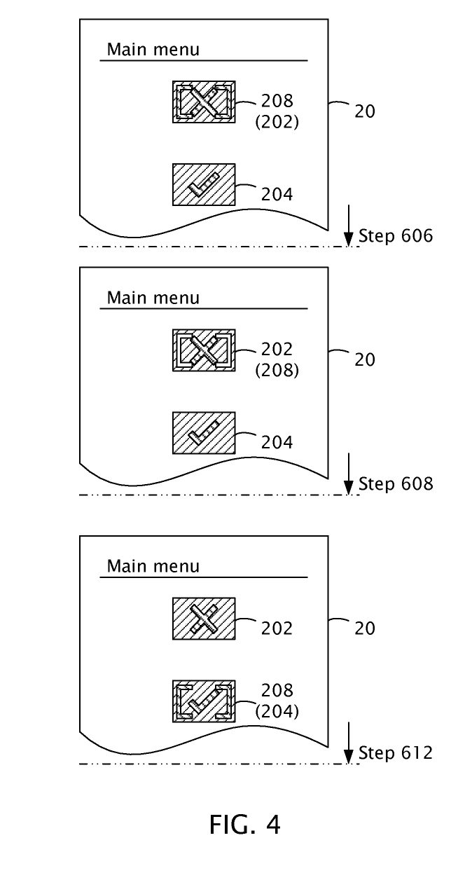

Referring to FIGS. 3, 4, the present method for displaying the dynamic OSD 20 may include the following steps 602˜610.

Step 602: displaying the OSD 20 with the color palette 40. In detail, the driver 108 reads the OSD image file (not shown) and renders it with the color palette 40.

Step 604: superimposing the icons 202, 204, 206 on the OSD 20 with the color palette 40. This step is also carried out by the driver 108.

Step 606: superimposing the fourth icon 208 over the first icon 202 with the color palette 40. In this embodiment, the fourth icon 208 is superposed over the first icon 202 and the background of the fourth icon 208 is colored with the transparent color. However, as discussed above, in other alternative embodiments, the fourth icon 208 can only partially overlapped with the first icon 202, and the background of the fourth icon 208 can be colored in any color.

Step 608: superposing the fourth icon 208 over the originally displayed fourth icon 208 with an auxiliary color palette 40s as shown in FIG. 2, where the auxiliary color palette 40s is essentially similar to the color palette 40 but replaces an indexed color of the color palette 40 corresponding to the background color of the originally displayed fourth icon 208 with a transparent color and another indexed color of the color palette 40 corresponding to the foreground color of the originally displayed fourth icon 208 with a non-color color. In detail, the auxiliary color palette 40s can be temporarily formed by sampling the background and foreground colors from the originally displayed fourth icon 208 and replacing the sampled colors with the transparent and non-color colors respectively. In detail, the color palette 40 and the auxiliary color palette 40s can be stored in the driver 108 or in the memory 102. As shown in the FIG. 4, after this step, the originally displayed fourth icon 208 is removed from the OSD 20, and only a minor area of the OSD 20, farther smaller than the area formed by conventional methods, is affected by the removal.

Step 610: superposing the first icon 202 over the originally displayed first icon 202 with the color palette 40. This step is for smoothing out the affected removal.

Step 612: superimposing the fourth icon 208 over the second icon 204. The details of this step are essentially similar to the step 606 and therefore detailed description is omitted here.

Since only a minor area of the OSD 20 is recolored in the process of performing the embodiment of the method, therefore, flickering caused in the process of changing OSD can be greatly reduced, even eliminated.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A method for displaying an on-screen display (OSD), comprising:
rendering an OSD with a first color palette, the OSD comprising a first and second icons superimposed thereon, the first and second icons both comprising a foreground and a background, the first and second icons being overlapped with each other, the first color palette comprising a collection of color entries and a collection colors, wherein each color entry is associated with a color; and
rendering the second icon with a second color palette and superposing the newly rendered second icon over the originally rendered second icon, wherein the second color palette is essentially similar to the first color palette but replaces a color of the first color palette corresponding to the background color of the originally rendered the second icon with a transparent color and another color of the first color palette corresponding to the foreground color of the originally rendered second icon with a non-color color.

2. The method as claimed in claim 1, wherein the first rendering step comprises:
rendering the OSD with the first color palette; and
rendering the first and second icons with the first color palette and superimposing them on the OSD.

3. The method as claimed in claim 1, wherein the first and second icons are partially overlapped.

4. The method as claimed in claim 1, wherein the first and second icons are superposed.

5. The method as claimed in claim 1, wherein first and second icons are essentially similar in shape and size, the second icon being superposed over the first icon, the background of the originally rendered second icon being rendered with the transparent color.

6. The method as claimed in claim 1, wherein the color entries are 4-bit binary integers, the first color palette comprises 16 colors.

7. The method as claimed in claim 1, wherein the second color palette is temporarily formed.

8. The method as claimed in claim 1, wherein the second color palette is formed by:
sampling the background and foreground colors from the originally displayed second icon; and
replacing the sampled colors with the transparent and non-color colors respectively.

9. The method as claimed in claim 1, further comprising:
rendering the first icon with the first color palette again after the newly rendered second icon is superposed over the originally rendered second icon; and
superposing the newly rendered first icon over the originally rendered first icon.

10. A method for displaying an on-screen display (OSD), comprising:
providing an electronic device with a display panel selected from the group consisting of desktop computer, laptop computer, camera, gaming device, and mobile phone.
rendering an OSD on the display panel with a first color palette, the OSD comprising a first and second icons superimposed thereon, the first and second icons both comprising a foreground and a background, the first and second icons being overlapped with each other, the first color palette comprising a collection of color entries and a collection colors, wherein each color entry is associated with a color; and
rendering the second icon with a second color palette and superposing the newly rendered second icon over the originally rendered second icon, wherein the second color palette is essentially similar to the first color palette but replaces a color of the first color palette corresponding to the background color of the originally rendered the second icon with a transparent color and another color of the first color palette corresponding to the foreground color of the originally rendered second icon with a non-color color.
